(19) United States
(12) Patent Application Publication
(10) Pub. No.: US 2026/0360818 A1
(43) Pub. Date: Nov. 12, 2026

(54) SECONDARY BATTERY AND ELECTRONIC APPARATUS

(71) Applicant: Dongguan Amperex Technology Limited, Dongguan (CN)

(72) Inventors: Shan ZHANG, Dongguan (CN); Jianyu LIU, Dongguan (CN); Chao TANG, Dongguan (CN)

(73) Assignee: Dongguan Amperex Technology Limited, Dongguan (CN)

(21) Appl. No.: 19/699,218

(22) Filed: Jun. 5, 2026

Related U.S. Application Data
(63) Continuation of application No. PCT/CN2023/137126, filed on Dec. 7, 2023.

(51) Int. Cl. H01M 10/0569; H01M 10/0525

(52) U.S. Cl. CPC H01M 10/0569; H01M 10/0525; H01M 2300/0034

(57) ABSTRACT

A secondary battery includes a positive electrode plate and an electrolyte, the positive electrode plate includes a positive electrode material layer, the positive electrode material layer includes a positive electrode active material, the positive electrode active material includes cobalt and nickel, and a mass percentage of the nickel is A % based on a mass of the positive electrode material layer, where 0.05≤A≤20. The electrolyte includes a fluorinated solvent, the fluorinated solvent includes at least one of a compound represented by formula (I), a compound represented by formula (II), a compound represented by formula (III), or a compound represented by formula (IV), and a mass percentage of the fluorinated solvent is B % based on a mass of the electrolyte, where 41.6≤B≤83.1.

### CROSS REFERENCE TO RELATED APPLICATION

This application is a continuation application of International Application No. PCT/CN2023/137126, filed on Dec. 7, 2023, the contents of which are incorporated herein by reference in its entirety.

### TECHNICAL FIELD

This application relates to the field of electrochemical technologies, and in particular, to a secondary battery and an electronic apparatus.

### BACKGROUND

Secondary batteries, such as lithium-ion batteries, have been widely used in consumer batteries due to their advantages such as high specific energy, light weight, and long cycle life. With the development of electronic products toward lightness and portability, people impose higher requirements for energy density, high-temperature cycling, charging speed, and the like of batteries.

Metal elements can be doped into the positive electrode active material to increase the gram capacity of the positive electrode active material, thereby improving the energy density of lithium-ion batteries.

### SUMMARY

The inventors of this application have found through research that nickel, as a doping element in the positive electrode active material, can increase the energy density of the secondary battery, and is cost-effective and environmentally friendly. However, after nickel is doped, the mixed arrangement of lithium and nickel atoms will hinder the migration of lithium ions and accelerate the structural collapse of the positive electrode active material during cycling, thereby affecting the high-temperature cycling performance of the lithium-ion battery.

In view of this, this application provides a secondary battery and an electronic apparatus, so that the secondary battery has high energy density and good high-temperature cycling performance. Specific technical solutions are as follows.

A first aspect of this application provides a secondary battery including a positive electrode plate, a negative electrode plate, and an electrolyte. The positive electrode plate includes a positive electrode material layer, the positive electrode material layer includes a positive electrode active material, the positive electrode active material includes cobalt and nickel, and a mass percentage of the nickel is A % based on a mass of the positive electrode material layer, where 0.05≤A≤20, and preferably 0.1≤A≤10. For example, the value of A may be 0.05, 0.1, 0.5, 1, 3, 5, 8, 10, 12, 15, 18, 20, or a value within a range defined by any two of these values. The electrolyte includes a fluorinated solvent, and the fluorinated solvent includes at least one of a compound represented by formula (I), a compound represented by formula (II), a compound represented by formula (III), or a compound represented by formula (IV):

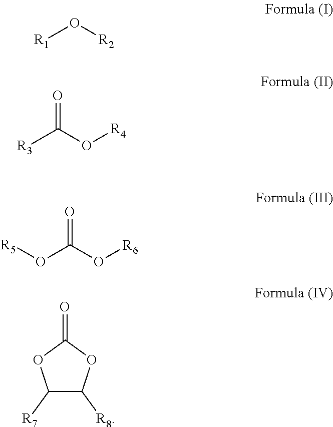

R₁ and R₂ are each independently selected from fluorine-substituted or unsubstituted C₁ to C₅ alkyl, fluorine-substituted or unsubstituted C₂ to C₅ alkenyl, fluorine-substituted or unsubstituted C₂ to C₅ alkynyl, sulfonic acid-substituted C₂ to C₅ alkyl, or cyano-substituted C₂ to C₅ alkyl; R₃ to R₈ are each independently selected from H, F, fluorine-substituted or unsubstituted C₁ to C₅ alkyl, fluorine-substituted or unsubstituted C₂ to C₅ alkenyl, fluorine-substituted or unsubstituted C₂ to C₅ alkynyl, sulfonic acid-substituted C₂ to C₅ alkyl, or cyano-substituted C₂ to C₅ alkyl; and at least one of R₁ and R₂ contains at least one fluorine atom, at least one of R₃ and R₄ contains at least one fluorine atom, at least one of R₅ and R₆ contains at least one fluorine atom, and at least one of R₇ and R₈ contains at least one fluorine atom. A mass percentage of the fluorinated solvent is B % based on a mass of the electrolyte, where 41.6≤B≤83.1, and preferably 45≤B≤75. For example, the value of B may be 41.6, 43, 45, 48, 50, 53, 55, 58, 60, 63, 65, 68, 70, 72, 75, 78, 80, 83.1, or a value within a range defined by any two of these values.

According to the secondary battery provided in this application, when the mass percentage A % of the nickel falls within the foregoing range, a secondary battery with high energy density can be obtained. The fluorinated solvent is added to the electrolyte and its mass percentage B % is controlled to fall within the foregoing range, so that a fluorine-containing interface protective film with high content can be continuously formed in situ on the surface of the positive electrode plate during charge and discharge cycles due to the fluorinated solvent with high content, which can continuously mitigate the dissolution of transition metals in the positive electrode material layer. In addition, the mixed arrangement of lithium and nickel atoms hinders the migration of Li+, accelerates the structural collapse of the positive electrode active material during cycling, and destroys the interface between the positive electrode plate and the electrolyte. The fluorinated solvent with high content can continuously repair the interface, thus eliminating the need to add an interface repair additive or reducing the content of the interface repair additive (such as vinylene carbonate or 1,3-propane sultone) in the electrolyte, which makes the initial impedance of the interface smaller, further increasing the energy density of the secondary battery. When the value of A is too small, for example, less than 0.05, it is not conducive to exerting the synergistic effect between the positive electrode plate and the electrolyte, and cannot increase the energy density of the secondary battery. When the value of A is too large, for example, greater than 20, it deteriorates the structural stability of the positive electrode active material, causes easy dissolution of transition metals, and cannot exert the synergistic effect between the positive electrode plate and the electrolyte, affecting the high-temperature cycling performance of the secondary battery. When the value of B is too small, for example, less than 41.6, the effect of the fluorinated solvent cannot be exerted, which is not conducive to mitigating the dissolution of transition metals in the positive electrode material layer. When the value of B is too large, for example, greater than 83.1, the conductivity is low, but the lithium fluoride formed in situ is excessive, which hinders the transmission of ions (such as lithium ions) and is not conducive to improving the high-temperature cycling performance of the secondary battery. The positive electrode active material includes the cobalt and the nickel, the electrolyte includes the fluorinated solvent, and the values of A and B are controlled to fall within the foregoing ranges, so that the synergistic effect is generated between the positive electrode plate and the electrolyte, which can make the secondary battery have high energy density and good high-temperature cycling performance. In this application, “high temperature” refers to a temperature greater than or equal to 35 °C.

In some embodiments of this application, 0.4≤B/10A≤83.1. For example, the value of B/10A may be 0.4, 1, 5, 10, 20, 30, 40, 41.6, 45, 50, 60, 70, 80, 83.1, or a value within a range defined by any two of these values. Controlling the value of B/10A to fall within the foregoing range is conducive to better exerting the synergistic effect between the positive electrode plate and the electrolyte, can reduce the dissolution of transition metals in the positive electrode material layer, and facilitates ion transmission, balancing the energy density and high-temperature cycling performance of the secondary battery, and improving the comprehensive performance of the secondary battery.

In some embodiments of this application, a mass percentage of the cobalt is C % based on the mass of the positive electrode material layer, where 40≤C≤60. For example, the value of C may be 40, 42, 45, 48, 50, 52, 55, 58, 60, or a value within a range defined by any two of these values. Controlling the value of C to fall within the foregoing range can obtain a positive electrode active material with high gram capacity, which helps to increase the energy density of the secondary battery. In addition, with the foregoing features, the structure of the positive electrode active material can be more stable, which is more conducive to exerting the synergistic effect between the positive electrode plate and the electrolyte, thereby improving the high-temperature cycling performance of the secondary battery, balancing the energy density and high-temperature cycling performance of the secondary battery, and improving the comprehensive performance of the secondary battery.

In some embodiments of this application, the positive electrode active material includes Li_{α}Co_{1-x-y}NiₓM_{y}O_{β}, where 0.95≤α≤1.4, 0.0005≤x≤0.4, 0≤y≤0.02, 1.9≤β≤2.1, and M includes at least one of Mn, Al, Mg, Ca, Ti, Zr, V, Cr, Fe, Cu, Zn, Rb, or Sn. For example, the value of α may be 0.95, 1, 1.1, 1.2, 1.3, 1.4, or a value within a range defined by any two of these values; the value of x may be 0.0005, 0.0008, 0.001, 0.002, 0.005, 0.008, 0.01, 0.05, 0.1, 0.15, 0.2, 0.25, 0.28, 0.3, 0.33, 0.35, 0.4, or a value within a range defined by any two of these values; the value of y may be 0, 0.001, 0.005, 0.01, 0.015, 0.02, or a value within a range defined by any two of these values; and the value of β may be 1.9, 1.95, 1.98, 2, 2.02, 2.05, 2.1, or a value within a range defined by any two of these values. The positive electrode active material may include but is not limited to at least one of LiCo_{0.94}Ni_{0.05}Mn_{0.01}O₂, LiCo_{0.89}Ni_{0.1}Mn_{0.01}O₂, LiCo_{0.84}Ni_{0.15}Mn_{0.01}O₂, LiCo_{0.79}Ni_{0.2}Mn_{0.01}O₂, LiCo_{0.85}Ni_{0.15}O₂, LiCo_{0.83}Ni_{0.15}Mn_{0.02}O₂, LiCo_{0.83}Ni_{0.15}Al_{0.02}O₂, or LiCo_{0.83}Ni_{0.15}Mg_{0.02}O₂. Using the foregoing positive electrode active material can make the structure of the positive electrode material layer more stable, which is more conducive to exerting the synergistic effect between the positive electrode plate and the electrolyte, balancing the energy density and high-temperature cycling performance of the secondary battery provided in this application.

In some embodiments of this application, the compound represented by formula (I) includes at least one of the following compounds:

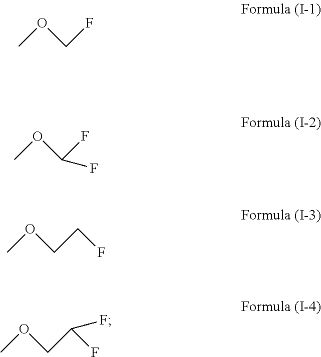

the compound represented by formula (II) includes at least one of the following compounds:

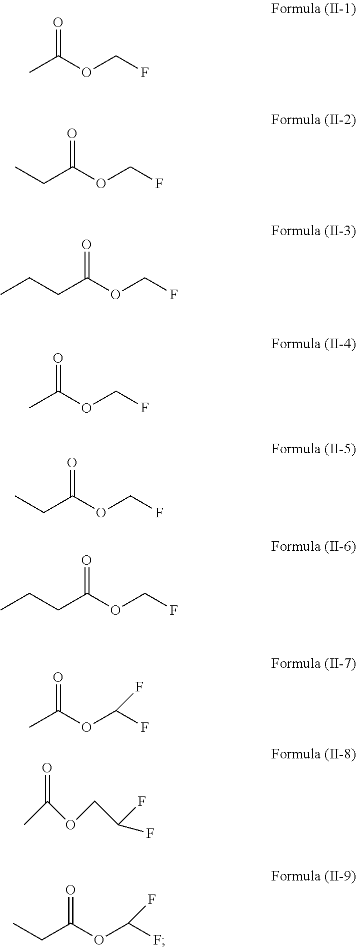

the compound represented by formula (III) includes at least one of the following compounds:

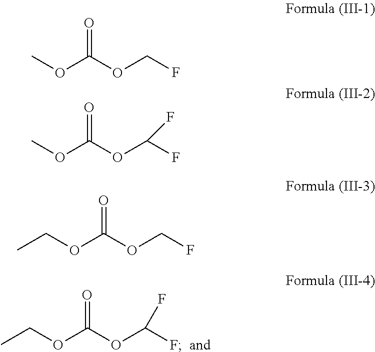

the compound represented by formula (IV) includes at least one of the following compounds:

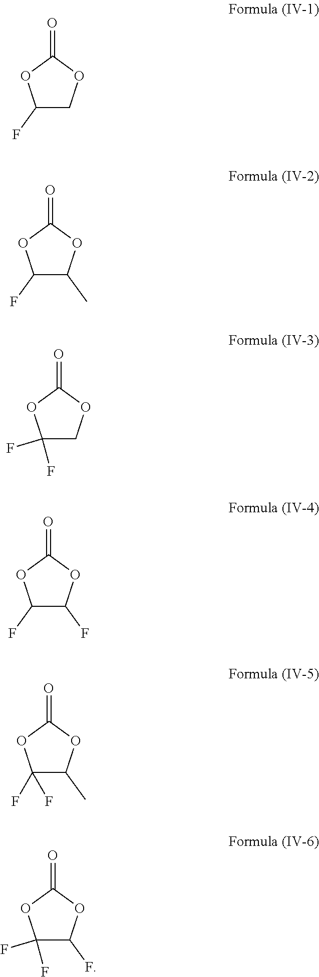

The fluorinated solvent including the foregoing compounds is conducive to forming a positive electrode solid electrolyte interface film (CEI film) with good conductivity on the surface of the positive electrode plate, and can also repair the interface between the positive electrode plate and the electrolyte, reduce the use of the interface repair additive, and make the initial impedance of the interface smaller, thereby helping to improve the energy density and high-temperature cycling performance of the secondary battery.

In some embodiments of this application, the electrolyte further includes a compound represented by formula (V):

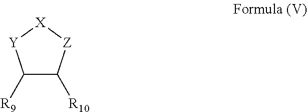

X is selected from any one of,

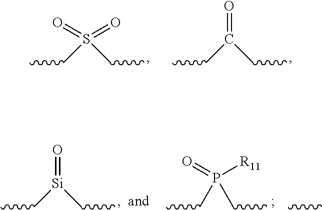

represents a bonding site with an adjacent atom; and Y and Z are each independently selected from any one of C and O. R₉, R₁₀, and R₁₁ are each independently selected from H, substituted or unsubstituted C₁ to C₁₀ alkyl, substituted or unsubstituted C₂ to C₁₀ alkenyl, substituted or unsubstituted C₂ to C₁₀ alkynyl, substituted or unsubstituted C₆ to C₁₀ aryl, substituted or unsubstituted C₁ to C₁₀ alkoxy, substituted or unsubstituted C₂ to C₁₀ cycloalkoxy, substituted or unsubstituted C₂ to C₁₀ alkenyloxy, substituted or unsubstituted C₂ to C₁₀ alkynyloxy, substituted or unsubstituted C₆ to C₁₀ aryloxy, substituted or unsubstituted C₁ to C₁₀ carboxyl, substituted or unsubstituted C₁ to C₁₀ carbonyl, substituted or unsubstituted C₁ to C₁₀ cyano, substituted or unsubstituted C₁ to C₁₀ amino, substituted or unsubstituted C₂ to C₁₀ carbonate, substituted or unsubstituted C₁ to C₁₀ sulfate, substituted or unsubstituted C₁ to C₁₀ sulfite, substituted or unsubstituted C₁ to C₁₀ borate, substituted or unsubstituted C₁ to C₁₀ silane, substituted or unsubstituted C₁ to C₁₀ siloxane, and substituted or unsubstituted C₁ to C₁₀ phosphate. When the foregoing groups are substituted, a substituent group of each group is independently selected from at least one of halogen atom or cyano. A mass percentage of the compound represented by formula (V) is D % based on the mass of the electrolyte, where 0.05≤D≤8. For example, the value of D may be 0.05, 0.1, 0.5, 1.5, 2, 3, 4, 5, 6, 7, 8, or a value within a range defined by any two of these values. The electrolyte includes the compound represented by formula (V) and the value of D is controlled to fall within the foregoing range, so that the compound represented by formula (V) can preferentially undergo oxidation reactions on a surface of a positive electrode to generate more oxidation-resistant sulfur-containing compounds, improving the oxidation resistance of the CEI film. In addition, the fluorinated solvent is prone to reduction reactions on the negative electrode plate, and the stability of its reduction product needs to be further improved. The compound represented by formula (V) can also react on a surface of a negative electrode prior to the fluorinated solvent, which reduces the probability of the fluorinated solvent undergoing reduction reactions on the surface of the negative electrode plate, and further improves the stability of the interface between the negative electrode plate and the electrolyte, further improving the high-temperature cycling performance of the secondary battery while enabling the secondary battery to have high energy density.

In some embodiments of this application, the compound represented by formula (V) includes at least one of the following compounds:

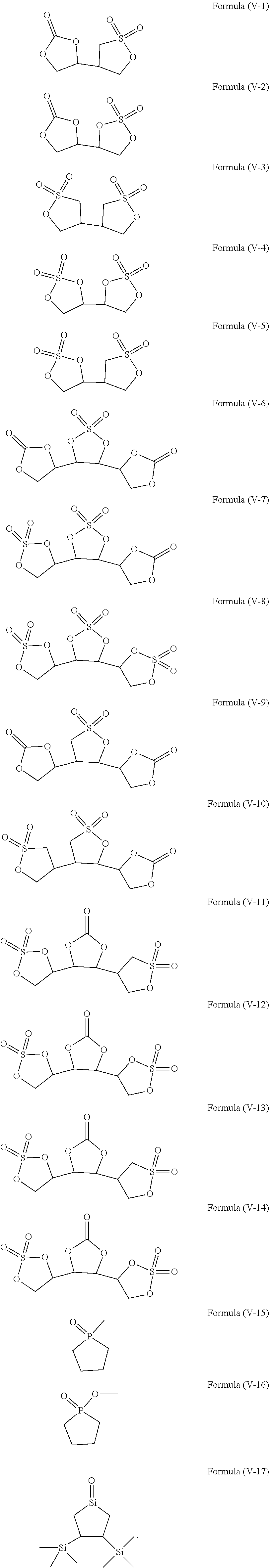

The compound represented by formula (V) including the foregoing compounds is more conducive to exerting the effect of the compound represented by formula (V), and further improves the oxidation resistance of the CEI film and the stability of the interface between the negative electrode plate and the electrolyte, further improving the high-temperature cycling performance of the secondary battery while enabling the secondary battery to have high energy density.

In some embodiments of this application, the electrolyte further includes a nitrile compound, and a percentage of the nitrile compound is E % based on the mass of the electrolyte, where 0.1≤E≤8. For example, the value of E may be 0.1, 0.5, 1, 2, 3, 4, 5, 6, 7, 8, or a value within a range defined by any two of these values. The nitrile compound includes malononitrile, succinonitrile, glutaronitrile, adiponitrile, suberonitrile, terephthalonitrile, tetradecanedinitrile, azomalononitrile, methyleneglutaronitrile, pentenedinitrile, 1,3,5-benzenetricarbonitrile, 2,4,6-trifluorobenzene-1,3,5-tricarbonitrile, 2-bromobenzene-1,3,5-tricarbonitrile, 1,3,6-hexanetricarbonitrile, 1,2,3-propanetricarbonitrile, 1,3,5-pentanetricarbonitrile, 1,2,6-hexanetricarbonitrile, or at least one of compounds represented by the following formula (VI):

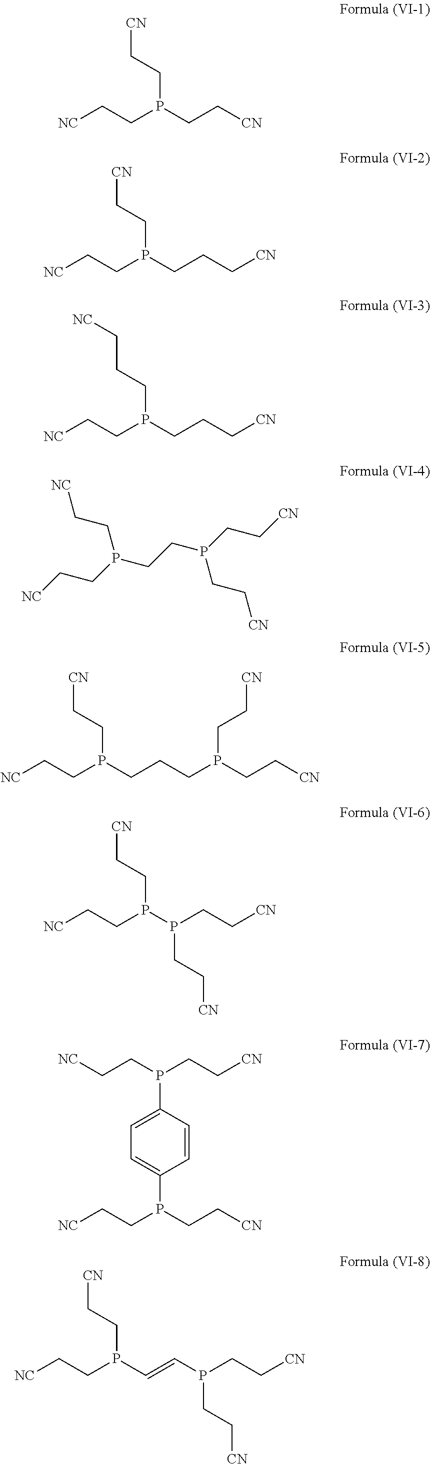

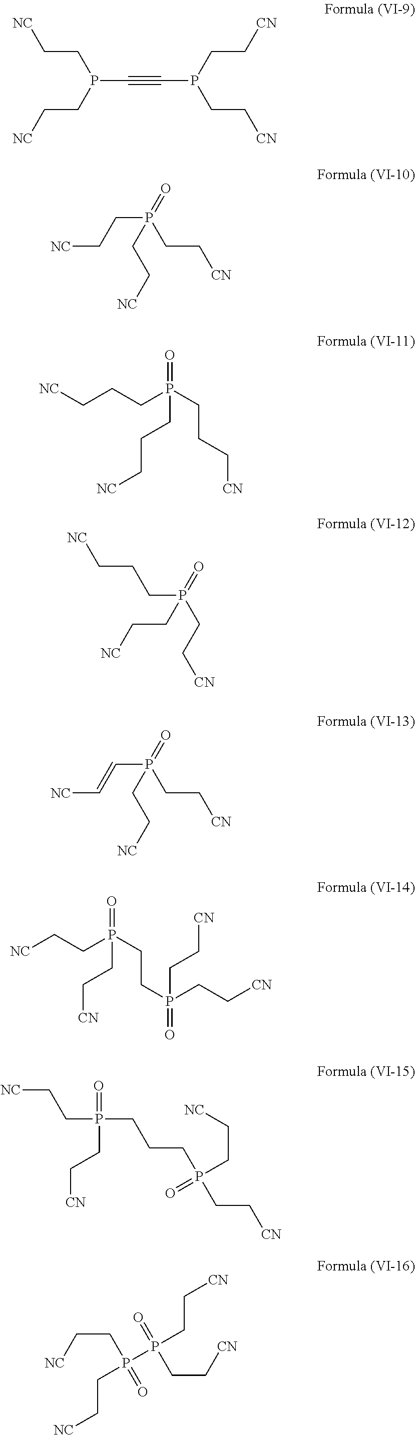

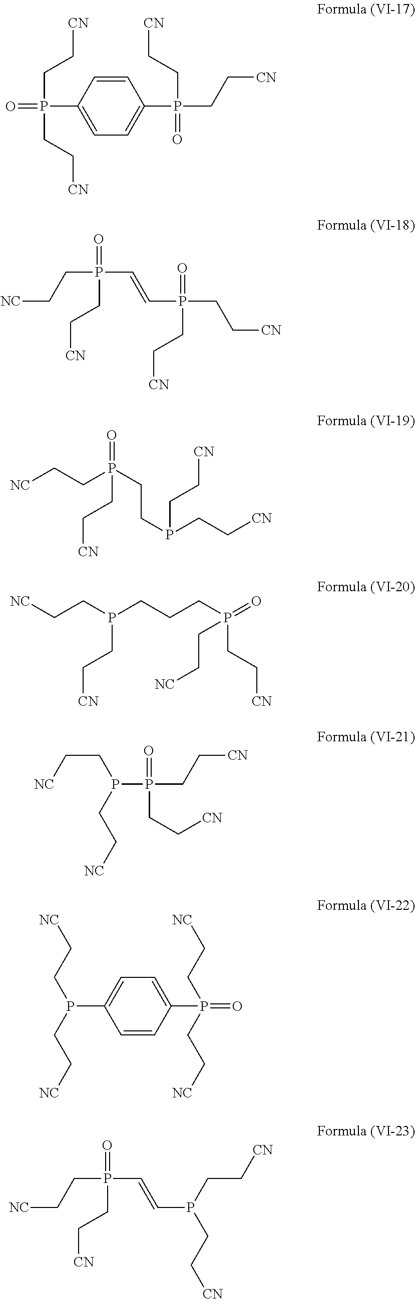

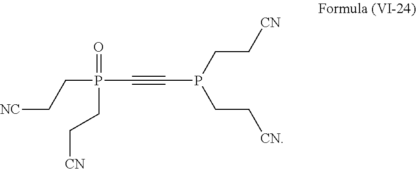 [SMILES: N#CCCP(C#CP(=O)(CCC#N)CCC#N)CCC#N]

The electrolyte includes the nitrile compound, and the fluorine-containing solvent and the nitrile compound synergistically participate in the construction of the CEI film, so that the composition of the CEI film includes both fluorine-containing compounds and cyano-containing compounds, which improves the oxidation resistance of the CEI film and stabilizes the transition metals in the positive electrode active material, reducing side reactions in the electrolyte, and inhibiting gas generated by oxidation and decomposition of the electrolyte at high temperature. In addition, the strong complexation of the nitrile compound on transition metals can further improve the high-temperature cycling performance of the secondary battery.

In some embodiments of this application, the electrolyte further includes a carbonate compound and a carboxylate compound and a mass percentage of the carbonate compound is F % and a mass percentage of the carboxylate compound is G % based on the mass of the electrolyte, where 8.3≤F≤33.3, and 8.3≤F+G≤41.6. For example, the value of F may be 8.3, 10, 12, 14, 15, 16, 18, 20, 24, 25, 28, 30, 33.3, or a value within a range defined by any two of these values; and the value of F+G may be 8.3, 10, 15, 20, 23, 25, 28, 30, 33, 35, 38, 40, 41.6, or a value within a range defined by any two of these values. The carbonate compound includes at least one of ethylene carbonate (EC), propylene carbonate (PC), butylene carbonate (BC), dimethyl carbonate (DMC), ethyl methyl carbonate (EMC), diethyl carbonate (DEC), dipropyl carbonate, methyl propyl carbonate (MPC), ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and the carboxylate compound includes at least one of methyl acetate (MA), ethyl acetate (EA), propyl acetate (PA), ethyl propionate (EP), propyl propionate (PP), butyl propionate, or amyl propionate. The electrolyte includes the carbonate compound and the carboxylate compound, and the values of F and F+G are controlled to fall within the foregoing ranges, so as to promote the dissociation of lithium salts and make the electrolyte have appropriate viscosity, which is conducive to the transmission of lithium ions, thereby improving the high-temperature cycling performance and rate performance of the secondary battery while enabling the secondary battery to have high energy density.

In some embodiments of this application, 0≤G≤21.6. For example, the value of G may be 0, 3, 5, 8, 8.3, 9, 10, 12, 14, 15, 16, 18, 20, 21.6, or a value within a range defined by any two of these values. Controlling the value of G to fall within the foregoing range can make the electrolyte have appropriate viscosity and accelerate the transmission of lithium ions, thereby improving the high-temperature cycling performance and rate performance of the secondary battery while enabling the secondary battery to have high energy density.

In some embodiments of this application, the electrolyte includes a lithium salt, and a mass percentage of the lithium salt is H % based on the mass of the electrolyte, where 8≤H≤20. For example, the value of H may be 8, 9, 10, 12, 13, 15, 16, 18, 20, or a value within a range defined by any two of these values. The lithium salt includes at least one of lithium hexafluorophosphate, lithium bistrifluoromethanesulfonimide, lithium bis(fluorosulfonyl)imide, lithium tetrafluoroborate, lithium bis(oxalato)borate, lithium difluoro(oxalato)borate, or lithium difluorophosphate. The electrolyte includes the lithium salt and the value of H is controlled to fall within the foregoing range, so that the ionic conductivity of the electrolyte can be improved, the charging time of the secondary battery can be shortened, and the oxidation reactions in the electrolyte can be reduced, thereby improving the high-temperature cycling performance of the secondary battery.

In some embodiments of this application, the electrolyte includes a lithium salt, a fluorinated solvent, a carbonate compound, and a carboxylate compound. In some embodiments, the electrolyte includes a lithium salt, a fluorinated solvent, and a carbonate compound, and the electrolyte further includes at least one of a compound represented by formula (V) or a nitrile compound. In some embodiments, the electrolyte includes a lithium salt, a fluorinated solvent, a carbonate compound, and a carboxylate compound, and optionally the electrolyte further includes at least one of a compound represented by formula (V) or a nitrile compound. In the foregoing composition, mass percentages of the lithium salt, fluorinated solvent, compound represented by formula (V), nitrile compound, carbonate compound, and carboxylate compound are as described above. Applying the foregoing electrolyte to a secondary battery can improve the high-temperature cycling performance of the secondary battery while enabling the secondary battery to have high energy density.

In some embodiments of this application, the electrolyte includes a lithium salt, a fluorinated solvent, and a carbonate compound. Mass percentages of the lithium salt and fluorinated solvent are as described above, and a mass percentage F % of the carbonate compound is 8.3% to 38.4%. For example, the value of F may be 8.3, 9, 10, 12, 14, 15, 16, 18, 20, 24, 25, 28, 30, 33.3, 35, 37, 38.4, or a value within a range defined by any two of these values. Applying the foregoing electrolyte to a secondary battery can improve the high-temperature cycling performance of the secondary battery while enabling the secondary battery to have high energy density. A preparation method of the positive electrode active material is not particularly limited in this application, provided that the objectives of this application can be achieved. For example, the preparation method of the positive electrode active material may include but is not limited to the following steps: LiCoO₂ (CAS number: 12190-79-3) and a nickel-containing compound are mixed to uniformity and then subjected to heat treatment in an air atmosphere to produce a positive electrode active material. The nickel-containing compound may include but is not limited to at least one of NiCO₃, NiO, or Ni(OH)₂. Temperature, time, and temperature rise velocity of the foregoing heat treatment are not particularly limited in this application, provided that the objectives of this application can be achieved. For example, the heat treatment is performed at a temperature of 650 °C to 850 °C, a time of 22 h to 26 h, and a temperature rise velocity of 2 °C/min to 8 °C/min. A mass ratio of LiCoO₂ to the nickel-containing compound is not particularly limited in this application, provided that the objectives of this application can be achieved. Typically, the mass ratio of LiCoO₂ to the nickel-containing compound can be changed to control the mass percentages of Co and Ni in the positive electrode active material. For example, increasing the mass ratio of LiCoO₂ to the nickel-containing compound leads to an increase in the mass percentage of Co and a decrease in the mass percentage of Ni; and decreasing the mass ratio of LiCoO₂ to the nickel-containing compound leads to a decrease in the mass percentage of Co and an increase in the mass percentage of Ni.

When the positive electrode active material includes the foregoing element M, both the nickel-containing compound and a compound containing the element M can be added during preparation of the positive electrode active material. For example, when the element M is Mg, Al, Ca, Ti, Zr, V, Cr, Fe, Mn, Cu, Zn, Rb, or Sn, the compound containing the element M added accordingly may be an oxide, hydroxide, or carbonate compound that contains the element M. The oxide, hydroxide, and carbonate compound that contain the element M are not limited in this application, provided that the objectives of this application can be achieved. The content of the element M in the positive electrode active material can be controlled by controlling the added amount of the compound containing the element M.

In this application, the positive electrode material layer may be disposed on one surface of a positive electrode current collector in its thickness direction, or on two surfaces of the positive electrode current collector in its thickness direction. It should be noted that the “surface” herein may be an entire region or a partial region of the surface of the positive electrode current collector. This is not particularly limited in this application, provided that the objectives of this application can be achieved. The positive electrode current collector is not particularly limited in this application, provided that the objectives of this application can be achieved. For example, the positive electrode current collector may include aluminum foil, aluminum alloy foil, a composite current collector (for example, an aluminum-carbon composite current collector), or the like.

The positive electrode material layer may further include a conductive agent and a binder. Types of the conductive agent and the binder are not particularly limited in this application, provided that the objectives of this application can be achieved. For example, the conductive agent may include but is not limited to at least one of conductive carbon black (Super P), carbon nanotubes (CNTs), carbon fiber, flake graphite, Ketjen black, graphene, a metal material, or a conductive polymer. The carbon nanotubes may include but are not limited to single-walled carbon nanotubes and/or multi-walled carbon nanotubes. The carbon fiber may include but is not limited to vapor grown carbon fiber (VGCF) and/or carbon nanofiber. The metal material may include but is not limited to metal powder and/or metal fiber, and specifically, the metal may include but is not limited to at least one of copper, nickel, aluminum, or silver. The conductive polymer may include but is not limited to at least one of polyphenylene derivative, polyaniline, polythiophene, polyacetylene, or polypyrrole. For example, the binder may include but is not limited to at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamide-imide, styrene-butadiene rubber, or polyvinylidene fluoride. A mass ratio of the positive electrode active material, the conductive agent, and the binder in the positive electrode material layer is not particularly limited in this application, and persons skilled in the art can make selection based on actual needs, provided that the objectives of this application can be achieved.

Thicknesses of the positive electrode current collector and the positive electrode material layer are not particularly limited in this application, provided that the objectives of this application can be achieved. For example, the thickness of the positive electrode current collector is 6 μm to 15 μm, and the thickness of the positive electrode material layer is 30 μm to 125 μm. Thickness of the positive electrode plate is not particularly limited in this application, provided that the objectives of this application can be achieved. For example, the thickness of the positive electrode plate is 50 μm to 260 μm.

In this application, the negative electrode plate includes a negative electrode current collector and a negative electrode material layer disposed on at least one surface of the negative electrode current collector. The “negative electrode material layer disposed on at least one surface of the negative electrode current collector” means that the negative electrode material layer may be disposed on one surface of the negative electrode current collector in its thickness direction, or on two surfaces of the negative electrode current collector in its thickness direction. It should be noted that the “surface” herein may be an entire region or a partial region of the surface of the negative electrode current collector. This is not particularly limited in this application, provided that the objectives of this application can be achieved.

The negative electrode current collector is not particularly limited in this application, provided that the objectives of this application can be achieved. For example, the negative electrode current collector may include copper foil, copper alloy foil, nickel foil, stainless steel foil, titanium foil, nickel foam, copper foam, a composite current collector (for example, a lithium-copper composite current collector, a carbon-copper composite current collector, a nickel-copper composite current collector, or a titanium-copper composite current collector), or the like. The negative electrode current collector may be a metal plate without through holes or a porous metal plate with through holes.

The negative electrode material layer includes a negative electrode active material, and the negative electrode active material is not particularly limited in this application, provided that the objectives of this application can be achieved. For example, the negative electrode active material may include but is not limited to at least one of natural graphite, artificial graphite, mesocarbon microbeads, hard carbon, soft carbon, silicon, silicon-carbon composite, Li—Sn alloy, Li—Sn—O alloy, Sn, SnO, SnO₂, spinel-structured lithiated TiO₂—Li₄Ti₅O₁₂, or Li—Al alloy. The negative electrode material layer may further include a conductive agent, a binder, and a thickener, and types of the conductive agent, the binder, and the thickener are not particularly limited in this application, provided that the objectives of this application can be achieved. For example, the conductive agent and the binder may be at least one of the foregoing conductive agents and binders, and the thickener may include but is not limited to at least one of sodium carboxymethyl cellulose or lithium carboxymethyl cellulose. A mass ratio of the negative electrode active material, the conductive agent, the binder, and the thickener in the negative electrode material layer is not particularly limited in this application, and persons skilled in the art can make selection based on actual needs, provided that the objectives of this application can be achieved.

Thickness of the negative electrode material layer is not particularly limited in this application, provided that the objectives of this application can be achieved. For example, the thickness of the negative electrode material layer on one surface is 30 μm to 170 μm. Thickness of the negative electrode current collector is not particularly limited in this application, provided that the objectives of this application can be achieved. For example, the thickness of the negative electrode current collector is 6 μm to 12 μm. Thickness of the negative electrode plate is not particularly limited in this application, provided that the objectives of this application can be achieved. For example, the thickness of the negative electrode plate is 50 μm to 350 μm.

In this application, the secondary battery further includes a separator. The separator is configured to separate the positive electrode plate from the negative electrode plate to prevent short circuit inside the secondary battery and to allow electrolyte ions to pass through freely without affecting electrochemical charging and discharging processes. The separator is not particularly limited in this application, provided that the objectives of this application can be achieved. For example, material of the separator may include but is not limited to at least one of polyethylene (PE) and polypropylene-based polyolefin (PO), polyester (for example, polyethylene terephthalate (PET) film), cellulose, polyimide (PI), polyamide (PA), spandex, or aramid. For example, polyethylene includes at least one of high-density polyethylene, low-density polyethylene, or ultra-high-molecular-weight polyethylene. Type of the separator may include at least one of woven film, non-woven film, microporous film, composite film, laminated film, or spinning film. Thickness of the separator is not particularly limited in this application, provided that the objectives of this application can be achieved. For example, the thickness of the separator may be 5 μm to 500 μm.

In some embodiments, the separator may include a substrate layer and a surface treatment layer. The substrate layer may be a non-woven fabric, film, or composite film having a porous structure, and material of the substrate layer may include at least one of polyethylene, polypropylene, polyethylene terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is disposed on at least one surface of the substrate layer, and the surface treatment layer may be a polymer layer, an inorganic material layer, or a layer formed by mixing a polymer and an inorganic material. For example, the inorganic material layer includes inorganic particles and a binder. The inorganic particle is not particularly limited, and for example, may include at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, and may be, for example, at least one of the foregoing binders. The polymer layer includes a polymer, and material of the polymer includes at least one of polyamide, polyacrylonitrile, acrylate polymer, polyacrylic acid, polyacrylate salt, polyvinylpyrrolidone, polyvinyl ether, polyvinylidene fluoride, or poly(vinylidene fluoride-hexafluoropropylene).

A preparation process of the secondary battery of this application is well known to persons skilled in the art, and is not particularly limited in this application. For example, the preparation process may include but is not limited to the following steps: a positive electrode plate, a separator, and a negative electrode plate are stacked in sequence and go through operations such as winding and folding as needed to obtain an electrode assembly with a winding structure, the electrode assembly is put into a packaging bag, an electrolyte is injected into the packaging bag, and the packaging bag is sealed to obtain a secondary battery. Alternatively, a positive electrode plate, a separator, and a negative electrode plate are stacked in sequence, four corners of the entire laminated structure are fixed with tapes to obtain an electrode assembly with a laminated structure, the electrode assembly is put into a packaging bag, an electrolyte is injected into the packaging bag, and the packaging bag is sealed to obtain a secondary battery. In addition, an overcurrent prevention element, a guide plate, and the like may also be placed into the packaging bag as needed, so as to prevent pressure increase, overcharge, and overdischarge inside the secondary battery. The packaging bag is a packaging bag known in the art, and is not limited in this application.

A second aspect of this application provides an electronic apparatus including the secondary battery provided in the first aspect of this application. The secondary battery provided in the first aspect of this application has high energy density and good high-temperature cycling performance, so that the electronic apparatus provided in the second aspect of this application has a long service life. Type of the electronic apparatus is not particularly limited in this application and the electronic apparatus may be any known electronic apparatus used in the prior art. In some embodiments of this application, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

This application provides a secondary battery and an electronic apparatus. The secondary battery includes a positive electrode plate, a negative electrode plate, and an electrolyte. The positive electrode plate includes a positive electrode material layer. The positive electrode material layer includes a positive electrode active material. The positive electrode active material includes cobalt and nickel. A mass percentage of the nickel is A % based on a mass of the positive electrode material layer, where 0.05≤A≤20. The electrolyte includes a fluorinated solvent, and the fluorinated solvent includes at least one of a compound represented by formula (I), a compound represented by formula (II), a compound represented by formula (III), or a compound represented by formula (IV). A mass percentage of the fluorinated solvent is B % based on a mass of the electrolyte, where 41.6≤B≤83.1. The positive electrode active material includes the cobalt and the nickel, the electrolyte includes the fluorinated solvent, and the values of A and B are controlled to fall within the foregoing ranges, so that the synergistic effect is generated between the positive electrode plate and the electrolyte, which can make the secondary battery have high energy density and good high-temperature cycling performance.

### DETAILED DESCRIPTION

To make the objectives, technical solutions, and advantages of this application more comprehensible, the following further describes this application in detail with reference to embodiments. Apparently, the described embodiments are only some but not all of the embodiments of this application. All other embodiments obtained by persons skilled in the art based on this application shall fall within the protection scope of this application.

It should be noted that in specific embodiments of this application, an example in which a lithium-ion battery is used as a secondary battery is used to illustrate this application. However, the secondary battery in this application is not limited to the lithium-ion battery.

### EXAMPLES

The following describes the embodiments of this application more specifically by using examples and comparative examples. Various tests and evaluations are performed according to the following methods. In addition, unless otherwise specified, “part” and “%” are based on mass.

### Test Methods and Equipment:

### Test for Mass Percentages of Co and Ni:

A lithium-ion battery was discharged to 3 V at 0.2 C, and then disassembled to take a positive electrode plate. A positive electrode material layer of the positive electrode plate washed with DMC (dimethyl carbonate) was scraped off with a scraper to obtain powder of the positive electrode material layer, and 0.4 g of the powder was dissolved by a 12 mL mixed solvent, where the mixed solvent was obtained by mixing aqua regia and HF at a volume ratio of 5:1. Then, the solution was diluted to 100 mL, and contents of metal elements such as Co and Ni in the solution were tested by using an inductively coupled plasma emission spectrometer (ICP). The mass percentage A % of Ni and the mass percentage C % of Co based on the mass of the positive electrode material layer were calculated. Aqua regia was obtained by mixing concentrated nitric acid and concentrated hydrochloric acid at a volume ratio of 1:1.

### Test for Percentages of Constituents in Electrolyte:

A lithium-ion battery was discharged to 3 V at 0.2 C, and then disassembled to collect an electrolyte. The obtained positive electrode plate, negative electrode plate, and separator were centrifuged. The liquid obtained after centrifugation was uniformly mixed with the electrolyte to obtain a liquid sample. The liquid sample was subjected to an ion chromatography (IC) test to obtain the percentage of the lithium salt in the electrolyte. The liquid sample was subjected to a gas chromatography-mass spectrometry (GC-MS) test to obtain the mass ratio of constituents in the electrolyte, and with reference to the obtained percentage of the lithium salt, the mass percentages of constituents in the electrolyte were calculated.

### Test for Discharge Gram Capacity:

The discharge gram capacity of the lithium-ion battery was used to evaluate the energy density of the lithium-ion battery. A larger discharge gram capacity indicates a higher energy density, and a smaller discharge gram capacity indicates a lower energy density. A lithium-ion battery was discharged to 3 V at 0.2 C, and then disassembled to take a positive electrode plate. The positive electrode plate was cut into circular plates with a diameter of 14 mm. The positive electrode material layer on one surface of the positive electrode plate was removed to obtain a positive electrode plate coated with the positive electrode material layer on one surface. A lithium metal plate was used as a counter electrode, and the composition of the separator and electrolyte was the same as that in the corresponding example or comparative example. Preparation of lithium-ion button battery: In a glove box, a negative electrode housing, a spacer, a lithium metal plate, a separator, a positive electrode plate, an elastic sheet, and a positive electrode housing were assembled in sequence and sealed on a sealing machine to obtain a battery. An electrolyte was added dropwise onto the spacer, the lithium metal plate, the separator, and the positive electrode plate, where a diameter of the lithium metal plate was 16 mm, and a diameter of the separator was 16.5 mm. At 25 °C, the prepared lithium-ion button battery was charged to a voltage of 4.5 V at 0.2 C, further charged to a current lower than 0.05 C at a constant voltage of 4.5 V, so that the battery was in a fully charged state of 4.5 V, and then discharged at a constant current of 0.2 C until the voltage was 3.0 V, to obtain a discharge capacity of the lithium-ion battery. Finally, the button battery was disassembled to take the positive electrode plate, cleaning and drying were performed, and the mass of the positive electrode plate was weighed. Then, the positive electrode material layer was scraped off, the positive electrode current collector was washed and dried, and the mass of the positive electrode current collector was weighed. Mass of positive electrode material layer=mass of positive electrode plate−mass of positive electrode current collector. Discharge gram capacity of lithium-ion battery=discharge capacity of lithium-ion battery/mass of positive electrode material layer.

### Test for High-Temperature Cycling Performance:

The capacity retention rate at 45 °C was used to evaluate the high-temperature cycling performance of the lithium-ion battery. A higher capacity retention rate indicates better high-temperature cycling performance, and a lower capacity retention rate indicates poorer high-temperature cycling performance. At 45 °C, the lithium-ion battery was charged to 4.52 V at a constant current of 0.7 C, then charged to a current of 0.05 C at a constant voltage of 4.5 V, and discharged to 3.0 V at a constant current of 1 C. This was one charge and discharge cycle. This was the first cycle, and a discharge capacity of the lithium-ion battery after the first cycle was recorded. The lithium-ion battery was subjected to 500 charge and discharge cycles in the foregoing method, and a discharge capacity after 500 cycles was recorded. Capacity retention rate at 45 °C=(discharge capacity after 500 cycles/discharge capacity after the first cycle)×100%.

### Example 1-1

### <Preparation of Positive Electrode Active Material>

Nickel carbonate (NiCO₃) and LiCoO₂ were mixed at a mass ratio of 17.8:83.2 in a high-speed mixer at 300 r/min for 20 min to obtain a mixture. The mixture was put into an air kiln, heated to 820 °C at 5 °C/min and held for 24 h, taken out after natural cooling, and sieved with a 300-mesh sieve to obtain a positive electrode active material.

### <Preparation of Positive Electrode Plate>

The prepared positive electrode active material, conductive agent carbon nanotubes (CNT), and binder polyvinylidene fluoride were mixed at a mass ratio of 97.9:0.7:1.4, N-methylpyrrolidone (NMP) was added as a solvent, and the mixture was stirred to uniformity using a vacuum stirrer to produce a positive electrode slurry with a solid content of 75 wt %. The positive electrode slurry was uniformly applied onto one surface of a 12 μm thick positive electrode current collector aluminum foil and dried at 85 °C, followed by cold pressing, to obtain a positive electrode plate with a 100 μm thick positive electrode material layer. Then, the same steps were repeated on the other surface of the aluminum foil to obtain a positive electrode plate coated with positive electrode material layers on two surfaces. The positive electrode plate was cut into a size of 74 mm×862 mm and then welded with tabs for use.

### <Preparation of Negative Electrode Plate>

Negative electrode active material artificial graphite, styrene-butadiene rubber (SBR), and carboxymethyl cellulose (CMC) were mixed at a mass ratio of 95:2:3, then deionized water was added as a solvent to prepare a slurry with a solid content of 70 wt %, and the slurry was stirred to uniformity. The slurry was uniformly applied onto one surface of an 8 μm thick copper foil and dried at 110 °C, followed by cold pressing, to obtain a negative electrode plate coated with a 150 μm thick negative electrode material layer on one surface. Then, the same steps were repeated on the other surface of the copper foil to obtain a negative electrode plate coated with negative electrode material layers on two surfaces. The negative electrode plate was cut into a size of 75 mm×867 mm and then welded with tabs for use.

### <Preparation of Electrolyte>

In an argon atmosphere glove box with a moisture content less than 10 ppm, fluorinated solvent formula (II-4) and carbonate compound diethyl carbonate (DEC) were mixed, and then lithium salt lithium hexafluorophosphate (LiPF₆) was added for dissolving and mixing to uniformity, to obtain an electrolyte. Based on the mass of the electrolyte, the mass percentage H % of the lithium salt was 12.5%, and the mass percentage B % of the fluorinated solvent and the mass percentage F % of the carbonate compound were as shown in Table 1.

### <Separator>

A 15 μm thick polyethylene porous film (manufacturer: Celgard Separator, LLC of USA) was used as a separator.

### <Preparation of Lithium-Ion Battery>

The prepared positive electrode plate, separator, and negative electrode plate were sequentially stacked so that the separator was located between the positive electrode plate and the negative electrode plate to provide separation. Then, the resulting stack was wound to obtain an electrode assembly. The electrode assembly was placed into an aluminum-plastic film packaging bag and dried in a vacuum oven at 85 °C for 12 h to remove moisture, and the prepared electrolyte was injected, followed by processes such as vacuum sealing, standing, formation (charged to 4.3 V at a constant current of 0.05 C and then discharged to 2.8 V at a constant current of 0.2 C), shaping, capacity testing, and secondary sealing, to obtain a lithium-ion battery.

### Examples 1-2 to 1-12

These examples were the same as Example 1-1 except that the related preparation parameters were adjusted according to Table 1. When the mass percentage of the fluorinated solvent changed, the mass percentage of the carbonate compound changed accordingly while the mass percentage of the lithium salt remained unchanged.

### Examples 1-13 to 1-22

These examples were the same as Example 1-1 except that the carboxylate compound propyl propionate (PP) was introduced in <Preparation of electrolyte>, and the mass percentage B % of the fluorinated solvent, the mass percentage F % of the carbonate compound, and the mass percentage G % of the carboxylate compound were adjusted according to Table 1 while the mass percentage of the lithium salt remained unchanged.

### Example 2-1

This example was the same as Example 1-1 except that the electrolyte prepared in the following <Preparation of electrolyte> was used.

### <Preparation of Electrolyte>

In an argon atmosphere glove box with a moisture content less than 10 ppm, fluorinated solvent formula (II-4) and carbonate compounds ethylene carbonate (EC) and diethyl carbonate (DEC) were mixed, and then lithium salt lithium hexafluorophosphate (LiPF₆) was added for dissolving and mixing to uniformity, to obtain an electrolyte. Based on the mass of the electrolyte, the mass percentage of the lithium salt was 12.5%, the mass percentage B % of the fluorinated solvent was 58.4%, and the mass percentages of the carbonate compounds ethylene carbonate (EC) and diethyl carbonate (DEC) were as shown in Table 2.

### Examples 2-2 to 2-7

These examples were the same as Example 1-1 except that the carboxylate compound was introduced in <Preparation of electrolyte>, and the type and mass percentage of the carbonate compound and the type and mass percentage of the carboxylate compound were adjusted according to Table 2. When the mass percentage of the carbonate compound and the mass percentage of the carboxylate compound changed, the mass percentage of the fluorinated solvent changed accordingly while the mass percentage of the lithium salt remained unchanged.

### Example 2-8

This example was the same as Example 1-1 except that the type and mass percentage of the carbonate compound were adjusted according to Table 2. When the mass percentage of the carbonate compound changed, the mass percentage of the fluorinated solvent changed accordingly while the mass percentage of the lithium salt remained unchanged.

### Example 3-1

This example was the same as Example 2-2 except that in <Preparation of positive electrode active material>, the manganese-containing compound manganese carbonate (MnCO₃) was added to the mixture to prepare the positive electrode active material with the composition as shown in Table 3.

### Example 3-2

This example was the same as Example 2-2 except that in <Preparation of positive electrode active material>, the aluminum-containing compound aluminum carbonate (Al₂(CO₃)₃) was added to the mixture to prepare the positive electrode active material with the composition as shown in Table 3.

### Example 3-3

This example was the same as Example 2-2 except that in <Preparation of positive electrode active material>, the magnesium-containing compound magnesium hydroxide was added to the mixture to prepare the positive electrode active material with the composition as shown in Table 3.

### Examples 4-1 to 4-11

These examples were the same as Example 2-2 except that the compound represented by formula (V) was introduced in <Preparation of electrolyte>, and the type and mass percentage of the compound represented by formula (V) were adjusted according to Table 4. When the mass percentage of the compound represented by formula (V) changed, the sum of the mass percentages of the fluorinated solvent, carbonate compound, and carboxylate compound changed accordingly while their mass ratio and the mass percentage of the lithium salt remained unchanged.

### Examples 5-1 to 5-16

These examples were the same as Example 2-2 except that the nitrile compound was introduced in <Preparation of electrolyte>, and the type and mass percentage of the nitrile compound were adjusted according to Table 5. When the mass percentage of the nitrile compound changed, the sum of the mass percentages of the fluorinated solvent, carbonate compound, and carboxylate compound changed accordingly while their mass ratio and the mass percentage of the lithium salt remained unchanged.

### Examples 6-1 to 6-3

These examples were the same as Example 2-2 except that the type and mass percentage of the lithium salt were adjusted according to Table 6. When the mass percentage of the lithium salt changed, the sum of the mass percentages of the fluorinated solvent, carbonate compound, and carboxylate compound changed accordingly while their mass ratio remained unchanged.

### Example 7-1

This example was the same as Example 2-2 except that the compound formula (V-1) represented by formula (V) and the nitrile compound succinonitrile were added in the preparation of electrolyte according to Table 7, and the sum of the mass percentages of the fluorinated solvent, carbonate compound, and carboxylate compound changed accordingly while their mass ratio and the mass percentage of the lithium salt remained unchanged.

### Comparative Example 1

This comparative example was the same as Example 1-1 except that the mass ratio of NiCO₃ to LiCoO₂ was adjusted according to Table 1, the fluorinated solvent was not added to the electrolyte, and the mass percentage of the carbonate compound changed accordingly while the mass percentage of the lithium salt remained unchanged.

### Comparative Examples 2 to 5

These comparative examples were the same as Example 1-1 except that the related preparation parameters were adjusted according to Table 1. When the mass percentage of the fluorinated solvent changed, the mass percentage of the carbonate compound changed accordingly while the mass percentage of the lithium salt remained unchanged.

Related parameters and performance tests of the examples and comparative examples are shown in Tables 1 to 7.

TABLE 1

| | | | | | | | | | | | Discharge | Capacity |
|---|---|---|---|---|---|---|---|---|---|---|---|---|
| | Mass ratio | | | | | | | | | | gram | retention rate |
| | of NiCO₃ | Positive electrode | | A | C | Fluorinated | B | | F | G | capacity | at 45 °C |
| | to LiCoO₂ | active material | X | (%) | (%) | solvent | (%) | B/10A | (%) | (%) | (mAh/g) | (%) |
| Example 1-1 | 17.8:83.2 | LiCo_{0.85}Ni_{0.15}O₂ | 0.15 | 8.8 | 50.1 | Formula | 83.1 | 0.94 | 4.4 | / | 178.6 | 78.2 |
| | | | | | | (II-4) | | | | | | |
| Example 1-2 | 0.1:97.8 | LiCo_{0.99915}Ni_{0.0085}O₂ | 0.0085 | 0.05 | 58.88 | Formula | 83.1 | 166.2 | 4.4 | / | 176.3 | 78.3 |
| | | | | | | (II-4) | | | | | | |
| Example 1-3 | 0.24:97.7 | LiCo_{0.998}Ni_{0.002}O₂ | 0.002 | 0.1 | 58.8 | Formula | 83.1 | 83.1 | 4.4 | / | 176.5 | 78.4 |
| | | | | | | (II-4) | | | | | | |
| Example 1-4 | 1.07:97 | LiCo_{0.991}Ni_{0.009}O₂ | 0.009 | 0.5 | 58.4 | Formula | 83.1 | 16.6 | 4.4 | / | 176.7 | 78.7 |
| | | | | | | (II-4) | | | | | | |
| Example 1-5 | 2.02:96.2 | LiCo_{0.0984}Ni_{0.017}O₂ | 0.017 | 1 | 57.9 | Formula | 83.1 | 8.3 | 4.4 | / | 177.0 | 80.1 |
| | | | | | | (II-4) | | | | | | |
| Example 1-6 | 8.19:91.1 | LiCo_{0.931}Ni_{0.069}O₂ | 0.069 | 4 | 54.9 | Formula | 83.1 | 2.08 | 4.4 | / | 177.8 | 80 |
| | | | | | | (II-4) | | | | | | |
| Example 1-7 | 20.3:81.2 | LiCo_{0.829}Ni_{0.171}O₂ | 0.171 | 10 | 48.9 | Formula | 83.1 | 0.83 | 4.4 | / | 179.2 | 79.3 |
| | | | | | | (II-4) | | | | | | |
| Example 1-8 | 40.4:64.5 | LiCo_{0.66}Ni_{0.34}O₂ | 0.34 | 20 | 38.9 | Formula | 83.1 | 0.42 | 4.4 | / | 179.6 | 78.5 |
| | | | | | | (II-4) | | | | | | |
| Example 1-9 | 38:66.6 | LiCo_{0.68}Ni_{0.32}O₂ | 0.32 | 18.8 | 40.1 | Formula | 54.1 | 0.29 | 33.4 | / | 179.4 | 77.8 |
| | | | | | | (II-4) | | | | | | |
| Example 1-10 | 17.8:83.2 | LiCo_{0.85}Ni_{0.15}O₂ | 0.15 | 8.8 | 50.1 | Formula | 74.9 | 0.85 | 12.6 | / | 178.7 | 80.1 |
| | | | | | | (II-4) | | | | | | |
| Example 1-11 | 17.8:83.2 | LiCo_{0.85}Ni_{0.15}O₂ | 0.15 | 8.8 | 50.1 | Formula | 66.6 | 0.76 | 20.9 | / | 178.8 | 80.5 |
| | | | | | | (II-4) | | | | | | |
| Example 1-12 | 17.8:83.2 | LiCo_{0.85}Ni_{0.15}O₂ | 0.15 | 8.8 | 50.1 | Formula | 58.4 | 0.66 | 29.1 | / | 179.0 | 81.3 |
| | | | | | | (II-4) | | | | | | |
| Example 1-13 | 17.8:83.2 | LiCo_{0.85}Ni_{0.15}O₂ | 0.15 | 8.8 | 50.1 | Formula | 54.1 | 0.61 | 33.3 | 0.1 | 179.2 | 82.9 |
| | | | | | | (II-4) | | | | | | |
| Example 1-14 | 17.8:83.2 | LiCo_{0.85}Ni_{0.15}O₂ | 0.15 | 8.8 | 50.1 | Formula | 49.9 | 0.57 | 33.3 | 4.3 | 179.0 | 81.5 |
| | | | | | | (II-4) | | | | | | |
| Example 1-15 | 17.8:83.2 | LiCo_{0.85}Ni_{0.15}O₂ | 0.15 | 8.8 | 50.1 | Formula | 45.8 | 0.52 | 33.3 | 8.4 | 178.8 | 80.8 |
| | | | | | | (II-4) | | | | | | |
| Example 1-16 | 17.8:83.2 | LiCo_{0.85}Ni_{0.15}O₂ | 0.15 | 8.8 | 50.1 | Formula | 41.6 | 0.47 | 33.3 | 12.6 | 178.6 | 79.5 |
| | | | | | | (II-4) | | | | | | |
| Example 1-17 | 17.8:83.2 | LiCo_{0.85}Ni_{0.15}O₂ | 0.15 | 8.8 | 50.1 | Formula | 54.1 | 0.61 | 33.3 | 0.1 | 180.0 | 82.7 |
| | | | | | | (I-4) | | | | | | |
| Example 1-18 | 17.8:83.2 | LiCo_{0.85}Ni_{0.15}O₂ | 0.15 | 8.8 | 50.1 | Formula | 54.1 | 0.61 | 33.3 | 0.1 | 179.8 | 83.5 |
| | | | | | | (II-8) | | | | | | |
| Example 1-19 | 17.8:83.2 | LiCo_{0.85}Ni_{0.15}O₂ | 0.15 | 8.8 | 50.1 | Formula | 54.1 | 0.61 | 33.3 | 0.1 | 179.6 | 83.6 |
| | | | | | | (III-2) | | | | | | |
| Example 1-20 | 17.8:83.2 | LiCo_{0.85}Ni_{0.15}O₂ | 0.15 | 8.8 | 50.1 | Formula | 54.1 | 0.61 | 33.3 | 0.1 | 179.7 | 82.4 |
| | | | | | | (III-4) | | | | | | |
| Example 1-21 | 17.8:83.2 | LiCo_{0.85}Ni_{0.15}O₂ | 0.15 | 8.8 | 50.1 | Formula | 54.1 | 0.61 | 33.3 | 0.1 | 179.5 | 83.1 |
| | | | | | | (IV-4) | | | | | | |
| Example 1-22 | 17.8:83.2 | LiCo_{0.85}Ni_{0.15}O₂ | 0.15 | 8.8 | 50.1 | Formula | 46.1 | 0.52 | 33.3 | 8.1 | 179.9 | 84 |
| | | | | | | (II-8) | | | | | | |
| Comparative | 0:100 | LiCoO₂ | / | / | 58.9 | / | / | / | 87.5 | / | 176.2 | 61 |
| Example 1 | | | | | | | | | | | | |
| Comparative | 0.06:97.9 | LiCo_{0.9995}Ni_{0.0005}O₂ | 0.0005 | 0.02 | 58.9 | Formula | 83.1 | 415.5 | 4.4 | / | 176.3 | 75 |
| Example 2 | | | | | | (II-4) | | | | | | |
| Comparative | 51.04:55.8 | LiCo_{0.57}Ni_{0.43}O₂ | 0.43 | 25.2 | 33.6 | Formula | 83.1 | 0.33 | 4.4 | / | 180.1 | 55.1 |
| Example 3 | | | | | | (II-4) | | | | | | |
| Comparative | 17.8:83.2 | LiCo_{0.85}Ni_{0.15}O₂ | 0.15 | 8.8 | 50.1 | Formula | 35 | 0.4 | 52.53 | / | 178.3 | 57 |
| Example 4 | | | | | | (II-4) | | | | | | |
| Comparative | 17.8:83.2 | LiCo_{0.85}Ni_{0.15}O₂ | 0.15 | 8.8 | 50.1 | Formula | 87 | 0.99 | 0.5 | / | 178.6 | 74.5 |
| Example 5 | | | | | | (II-4) | | | | | | |

Note:
″/″ in Table 1 means that a corresponding material or parameter does not exist.

It can be learned from Examples 1-1 to 1-22 and Comparative Examples 1 to 5 that when the positive electrode active material includes the cobalt and the nickel, the electrolyte includes the fluorinated solvent, and the values of A and B are controlled to fall within the ranges of this application, the lithium-ion battery has higher discharge gram capacity and capacity retention rate at 45 °C, indicating that the lithium-ion battery has higher energy density and better high-temperature cycling performance. The positive electrode active material does not include the nickel and the electrolyte does not include the fluorinated solvent in Comparative Example 1, and at least one of A or B is not within the range of this application in Comparative Examples 2 to 5, resulting in lower discharge gram capacity and/or capacity retention rate at 45 °C of the lithium-ion battery, indicating that the lithium-ion battery has lower energy density and poorer high-temperature cycling performance.

The value of A usually affects the energy density and high-temperature cycling performance of the lithium-ion battery. It can be learned from Examples 1-1 to 1-9 and Comparative Examples 2 and 3 that when A is too small, for example, in Comparative Example 2, compared with the lithium-ion battery using a positive electrode active material not including nickel (for example, in Comparative Example 1), the lithium-ion battery has relatively low discharge gram capacity. When A is too large, for example, in Comparative Example 3, although the discharge gram capacity of the lithium-ion battery can be increased, its capacity retention rate at 45 °C is low, which is not conducive to the high-temperature cycling performance of the lithium-ion battery, indicating that the discharge gram capacity and high-temperature cycling performance of the lithium-ion battery are difficult to balance. Therefore, the value of A is controlled to fall within the range of this application, so that the lithium-ion battery has higher discharge gram capacity and capacity retention rate at 45 °C, indicating that the lithium-ion battery has higher energy density and better high-temperature cycling performance.

The value of B usually affects the energy density and high-temperature cycling performance of the lithium-ion battery. It can be learned from Examples 1-1, 1-10 to 1-16, and 1-22 and Comparative Examples 4 and 5 that when B is too small, for example, in Comparative Example 4, the lithium-ion battery has low capacity retention rate at 45 °C; and when B is too large, for example, in Comparative Example 5, the lithium-ion battery has low capacity retention rate at 45 °C, indicating that when the value of B is too large or too small, the high-temperature cycling performance of the lithium-ion battery cannot be improved. Therefore, the value of B is controlled to fall within the range of this application, so that the lithium-ion battery has higher discharge gram capacity and capacity retention rate at 45 °C, indicating that the lithium-ion battery has higher energy density and better high-temperature cycling performance.

The value of B/10A usually affects the energy density and high-temperature cycling performance of the lithium-ion battery. It can be learned from Examples 1-1 to 1-16 and 1-22 that when the value of B/10A is controlled to fall within the range of this application, the lithium-ion battery has higher discharge gram capacity and capacity retention rate at 45 °C, indicating that the lithium-ion battery has higher energy density and better high-temperature cycling performance.

The value of C usually affects the energy density and high-temperature cycling performance of the lithium-ion battery. It can be learned from Examples 1-1 to 1-9 that when the value of C is controlled to fall within the range of this application, the lithium-ion battery has higher discharge gram capacity and capacity retention rate at 45 °C, indicating that the lithium-ion battery has higher energy density and better high-temperature cycling performance.

The type of the fluorinated solvent usually affects the energy density and high-temperature cycling performance of the lithium-ion battery. It can be learned from Examples 1-1 and 1-17 to 1-21 that when the fluorinated solvent within the range of this application is used, the lithium-ion battery has higher discharge gram capacity and capacity retention rate at 45 °C, indicating that the lithium-ion battery has higher energy density and better high-temperature cycling performance.

TABLE 2

| | | | | | | | Capacity |
|---|---|---|---|---|---|---|---|
| | | | | | | Discharge gram | retention rate |
| | Carbonate | F | Carboxylate | G | F + G | capacity | at 45 °C |
| | compound | (%) | compound | (%) | (%) | (mAh/g) | (%) |
| Example | DEC | 4.4 | / | 0 | 4.4 | 178.6 | 78.2 |
| 1-1 | | | | | | | |
| Example | DEC | 33.3 | / | 0 | 33.3 | 179.8 | 83.5 |
| 1-18 | | | | | | | |
| Example | EC + DEC | 10 + 19.1 | / | 0 | 29.1 | 180.0 | 84.1 |
| 2-1 | | | | | | | |
| Example | EC | 10 | PP | 19.1 | 29.1 | 180.2 | 84.6 |
| 2-2 | | | | | | | |
| Example | EC | 10 | EP | 19.1 | 29.1 | 180.4 | 84.5 |
| 2-3 | | | | | | | |
| Example | PC | 10 | EP | 19.1 | 29.1 | 180.3 | 84.7 |
| 2-4 | | | | | | | |
| Example | PC | 10 | PP | 19.1 | 29.1 | 180.1 | 84.8 |
| 2-5 | | | | | | | |
| Example | EC | 15 | PP | 10 | 25 | 180.2 | 84.8 |
| 2-6 | | | | | | | |
| Example | EC | 20 | PP | 21.6 | 41.6 | 179.9 | 83.6 |
| 2-7 | | | | | | | |
| Example | EC | 8.3 | / | 0 | 8.3 | 178.7 | 81.7 |
| 2-8 | | | | | | | |

Note:
“/” in Table 2 means that a corresponding material does not exist.

The types of the carbonate compound and carboxylate compound usually affect the energy density and high-temperature cycling performance of the lithium-ion battery. It can be learned from Examples 1-1, 1-18, and 2-1 to 2-5 that when the carbonate compound and carboxylate compound within the ranges of this application are used, the lithium-ion battery has higher discharge gram capacity and capacity retention rate at 45 °C, indicating that the lithium-ion battery has higher energy density and better high-temperature cycling performance.

The mass percentage F % of the carbonate compound, the mass percentage G % of the carboxylate compound, and the value of F+G usually affect the energy density and high-temperature cycling performance of the lithium-ion battery. It can be learned from Examples 1-1, 1-18, 2-1, and 2-6 to 2-8 that when the values of F, G, and F+G are controlled to fall within the ranges of this application, the lithium-ion battery has higher discharge gram capacity and capacity retention rate at 45 °C, indicating that the lithium-ion battery has higher energy density and better high-temperature cycling performance.

TABLE 3

| | | | | | | Discharge | Capacity |
|---|---|---|---|---|---|---|---|
| | | | | | | gram | retention rate |
| | Positive electrode | Element | | | | capacity | at 45 °C |
| | active material | M | y | A(%) | C(%) | (mAh/g) | (%) |
| Example | LiCo_{0.85}Ni_{0.15}O₂ | / | 0 | 8.8 | 50.1 | 180.2 | 84.6 |
| 2-2 | | | | | | | |
| Example | LiCo_{0.83}Ni_{0.15}Mn_{0.02}O₂ | Mn | 0.02 | 8.8 | 49 | 179.3 | 88.1 |
| 3-1 | | | | | | | |
| Example | LiCO_{0.83}Ni_{0.15l}Al_{0.02}O₂ | Al | 0.02 | 8.9 | 49.3 | 180.5 | 85.5 |
| 3-2 | | | | | | | |
| Example | LiCO_{0.83}Ni_{0.15}Mg_{0.02}O₂ | Mg | 0.02 | 8.9 | 49.3 | 180.7 | 86.5 |
| 3-3 | | | | | | | |

Note:
“/” in Table 3 means that a corresponding material does not exist.

The types of the positive electrode active material and element M usually affect the energy density and high-temperature cycling performance of the lithium-ion battery. It can be learned from Examples 1-1, 2-1, and 3-1 to 3-3 that when the positive electrode active material includes the element M within the range of this application, the lithium-ion battery has higher discharge gram capacity and capacity retention rate at 45 °C, indicating that the lithium-ion battery has higher energy density and better high-temperature cycling performance.

TABLE 4

| | | | Discharge | Capacity |
|---|---|---|---|---|
| | Compound | | gram | retention |
| | represented by | D | capacity | rate at |
| | formula (V) | (%) | (mAh/g) | 45 °C (%) |
| Example 2-2 | / | 0 | 180.2 | 84.6 |
| Example 4-1 | Formula (V-1) | 0.05 | 181.0 | 84.8 |
| Example 4-2 | Formula (V-1) | 1 | 180.8 | 85.4 |
| Example 4-3 | Formula (V-1) | 2 | 180.9 | 87.4 |
| Example 4-4 | Formula (V-1) | 3 | 180.7 | 88.5 |
| Example 4-5 | Formula (V-1) | 5 | 181.0 | 85.1 |
| Example 4-6 | Formula (V-1) | 8 | 180.9 | 84.6 |
| Example 4-7 | Formula (V-4) | 3 | 180.8 | 86.6 |
| Example 4-8 | Formula (V-5) | 3 | 180.9 | 87.8 |
| Example 4-9 | Formula (V-12) | 3 | 180.8 | 87.3 |
| Example 4-10 | Formula (V-16) | 3 | 181.0 | 87.6 |
| Example 4-11 | Formula (V-17) | 3 | 184.7 | 88.2 |

Note:
“/” in Table 4 means that a corresponding material does not exist.

The mass percentage D % of the compound represented by formula (V) usually affects the energy density and high-temperature cycling performance of the lithium-ion battery. It can be learned from Examples 2-2 and 4-1 to 4-6 that when the value of D is controlled to fall within the range of this application, the lithium-ion battery has higher discharge gram capacity and capacity retention rate at 45 °C, indicating that the lithium-ion battery has higher energy density and better high-temperature cycling performance.

The type of the compound represented by formula (V) usually affects the energy density and high-temperature cycling performance of the lithium-ion battery. It can be learned from Examples 4-1 and 4-7 to 4-11 that when the compound represented by formula (V) within the range of this application is used, the lithium-ion battery has higher discharge gram capacity and capacity retention rate at 45 °C, indicating that the lithium-ion battery has higher energy density and better high-temperature cycling performance.

TABLE 5

| | | | Discharge | Capacity |
|---|---|---|---|---|
| | | | gram | retention |
| | | E | capacity | rate at |
| | Nitrile compound | (%) | (mAh/g) | 45 °C (%) |
| Example 2-2 | / | 0 | 180.2 | 84.6 |
| Example 5-1 | Succinonitrile | 2 | 180.8 | 87.6 |
| Example 5-2 | Succinonitrile | 0.1 | 180.9 | 84.7 |
| Example 5-3 | Succinonitrile | 8 | 180.7 | 84.8 |
| Example 5-4 | Succinonitrile + 1,3,6- | 0.2 | 180.9 | 85.1 |
| | hexanetricarbonitrile | | | |
| Example 5-5 | Succinonitrile + 1,3,6- | 1 | 180.9 | 85.9 |
| | hexanetricarbonitrile | | | |
| Example 5-6 | Succinonitrile + 1,3,6- | 4 | 180.8 | 89.3 |
| | hexanetricarbonitrile | | | |
| Example 5-7 | Succinonitrile + 1,3,6- | 6 | 180.8 | 91.6 |
| | hexanetricarbonitrile | | | |
| Example 5-8 | Succinonitrile + 1,3,6- | 8 | 180.7 | 86.2 |
| | hexanetricarbonitrile | | | |
| Example 5-9 | Succinonitrile + 1,3,6- | 12 | 180.5 | 76.9 |
| | hexanetricarbonitrile | | | |
| Example 5-10 | Adiponitrile | 2 | 180.8 | 86.3 |
| Example 5-11 | Suberonitrile | 2 | 181.0 | 85.9 |
| Example 5-12 | Formula (VI-1) | 2 | 180.9 | 86.3 |
| Example 5-13 | Formula (VI-8) | 2 | 180.8 | 88.4 |
| Example 5-14 | Formula (VI-9) | 2 | 180.7 | 86.7 |
| Example 5-15 | Formula (VI-12) | 2 | 181.0 | 86.8 |
| Example 5-16 | Formula (VI-17) | 2 | 180.8 | 87.2 |

Note:
“/” in Table 5 means that a corresponding material does not exist. In Examples 5-4 to 5-9, the mass ratio of succinonitrile to 1,3,6-hexanetricarbonitrile is 1:1.

The mass percentage E % of the nitrile compound usually affects the energy density and high-temperature cycling performance of the lithium-ion battery. It can be learned from Examples 2-2 and 5-1 to 5-9 that when the value of E is controlled to fall within the range of this application, the lithium-ion battery has higher discharge gram capacity and capacity retention rate at 45 °C, indicating that the lithium-ion battery has higher energy density and better high-temperature cycling performance.

The type of the nitrile compound usually affects the energy density and high-temperature cycling performance of the lithium-ion battery. It can be learned from Examples 5-1 and 5-10 to 5-16 that when the nitrile compound within the range of this application is used, the lithium-ion battery has higher discharge gram capacity and capacity retention rate at 45 °C, indicating that the lithium-ion battery has higher energy density and better high-temperature cycling performance.

TABLE 6

| | | | Discharge | Capacity |
|---|---|---|---|---|
| | | | gram | retention |
| | | H | capacity | rate at |
| | Lithium salt | (%) | (mAh/g) | 45 °C (%) |
| Example 2-2 | LiPF₆ | 12.5 | 180.2 | 84.6 |
| Example 6-1 | LiPF₆ | 8 | 181.1 | 84.3 |
| Example 6-2 | LiPF₆ | 20 | 180.8 | 85.1 |
| Example 6-3 | LiBOB + LiTFSI | 0.5 + 12 | 181.2 | 85.3 |

Note:
“0.5 + 12” in Table 6 means that the mass percentage of LiBOB is 0.5% and the mass percentage of LiTFSI is 12%.

The mass percentage H % of the lithium salt usually affects the energy density and high-temperature cycling performance of the lithium-ion battery. It can be learned from Examples 2-2, 6-1, and 6-2 that when the value of H is controlled to fall within the range of this application, the lithium-ion battery has higher discharge gram capacity and capacity retention rate at 45 °C, indicating that the lithium-ion battery has higher energy density and better high-temperature cycling performance.

The type of the lithium salt usually affects the energy density and high-temperature cycling performance of the lithium-ion battery. It can be learned from Examples 6-1 and 6-3 that when the lithium salt within the range of this application is used, the lithium-ion battery has higher discharge gram capacity and capacity retention rate at 45 °C, indicating that the lithium-ion battery has higher energy density and better high-temperature cycling performance.

TABLE 7

| | | | | | | | | Capacity |
|---|---|---|---|---|---|---|---|---|
| | | | | | | | Discharge gram | retention rate |
| | | | | | | F + G | capacity | at 45 °C |
| | B (%) | D (%) | E (%) | F (%) | G (%) | (%) | (mAh/g) | (%) |
| Example 2-2 | 58.4 | / | / | 10 | 19.1 | 29.1 | 180.2 | 84.6 |
| Example 4-4 | 56.4 | 3 | / | 9.7 | 18.4 | 28.1 | 180.7 | 88.5 |
| Example 5-1 | 57.1 | 1 | 2 | 9.8 | 18.6 | 28.4 | 180.8 | 87.6 |
| Example 7-1 | 55.1 | 3 | 2 | 9.4 | 18.0 | 27.4 | 180.8 | 89.3 |

Note:
“/” in Table 7 means that a corresponding material is not added.

It can be learned from Examples 2-2, 4-4, 5-1, and 7-1 that when the electrolyte includes the fluorinated solvent, the carbonate compound, the carboxylate compound, the compound represented by formula (V), and the nitrile compound, and the values of B, D, E, F, and G are controlled to fall within the ranges of this application, the lithium-ion battery has higher discharge gram capacity and capacity retention rate at 45 °C, indicating that the lithium-ion battery has higher energy density and better high-temperature cycling performance.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising a positive electrode plate, a negative electrode plate, and an electrolyte; wherein the positive electrode plate comprises a positive electrode material layer, the positive electrode material layer comprises a positive electrode active material, the positive electrode active material comprises cobalt and nickel, and a mass percentage of the nickel is A % based on a mass of the positive electrode material layer, wherein 0.05≤A≤20;
the electrolyte comprises a fluorinated solvent; and the fluorinated solvent comprises at least one of a compound represented by formula (I), a compound represented by formula (II), a compound represented by formula (III), or a compound represented by formula (IV): 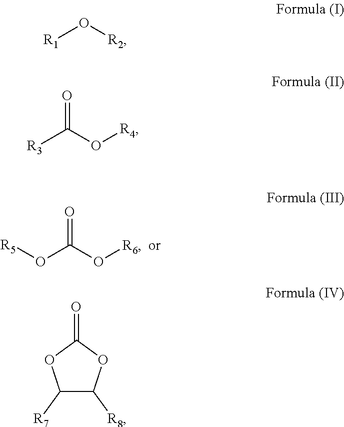
wherein R₁ and R₂ are each independently selected from fluorine-substituted or unsubstituted C₁ to C₅ alkyl, fluorine-substituted or unsubstituted C₂ to C₅ alkenyl, fluorine-substituted or unsubstituted C₂ to C₅ alkynyl, sulfonic acid-substituted C₂ to C₅ alkyl, or cyano-substituted C₂ to C₅ alkyl; R₃ to R₈ are each independently selected from H, F, fluorine-substituted or unsubstituted C₁ to C₅ alkyl, fluorine-substituted or unsubstituted C₂ to C₅ alkenyl, fluorine-substituted or unsubstituted C₂ to C₅ alkynyl, sulfonic acid-substituted C₂ to C₅ alkyl, or cyano-substituted C₂ to C₅ alkyl; and at least one of R₁ and R₂ contains at least one fluorine atom, at least one of R₃ and R₄ contains at least one fluorine atom, at least one of R₅ and R₆ contains at least one fluorine atom, and at least one of R₇ and R₈ contains at least one fluorine atom; and
a mass percentage of the fluorinated solvent is B % based on a mass of the electrolyte, wherein 41.6≤B≤83.1.

2. The secondary battery according to claim 1, wherein 0.1≤A≤10, and 45≤B≤75.

3. The secondary battery according to claim 1, wherein 0.4≤B/10A≤83.1.

4. The secondary battery according to claim 1, wherein a mass percentage of the cobalt is C % based on the mass of the positive electrode material layer, wherein 40≤C≤60.

5. The secondary battery according to claim 1, wherein the positive electrode active material comprises Li_{α}Co_{1-x-y}NiₓM_{y}O_{β}, wherein 0.95≤α≤1.4, 0.0005≤x≤0.4, 0≤y≤0.02, 1.9≤β≤2.1, and M comprises at least one of Mn, Al, Mg, Ca, Ti, Zr, V, Cr, Fe, Cu, Zn, Rb, or Sn.

6. The secondary battery according to claim 1, wherein the compound represented by formula (I) comprises at least one of the following compounds: 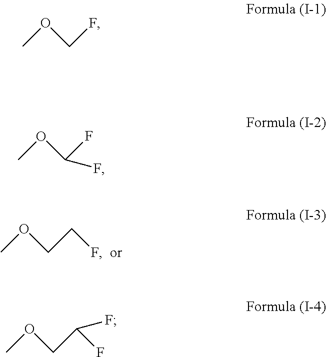
the compound represented by formula (II) comprises at least one of the following compounds: 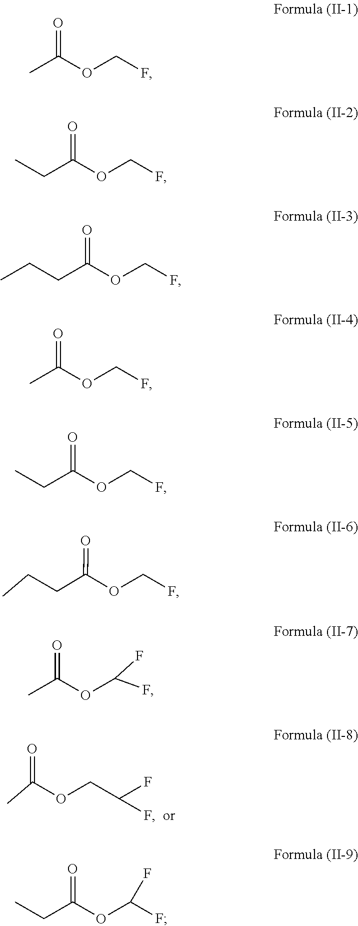
the compound represented by formula (III) comprises at least one of the following compounds: 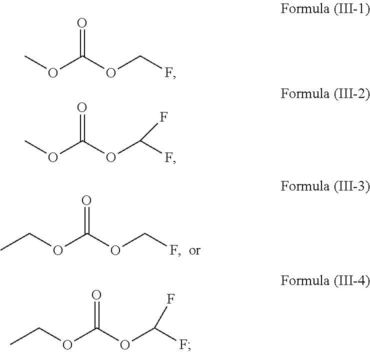
and
the compound represented by formula (IV) comprises at least one of the following compounds:

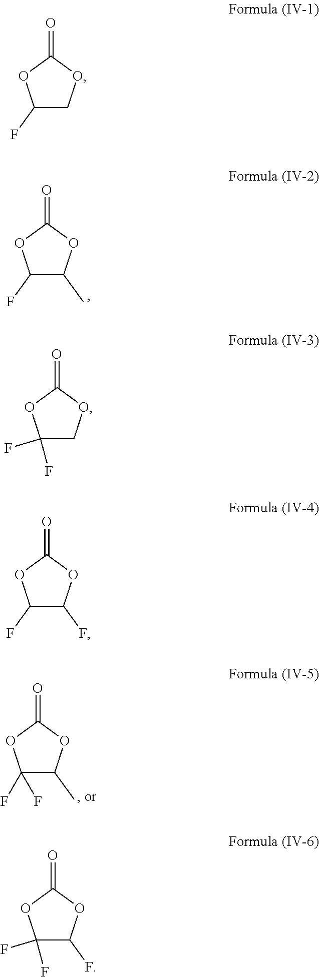

7. The secondary battery according to claim 1, wherein the electrolyte further comprises a compound represented by formula (V): 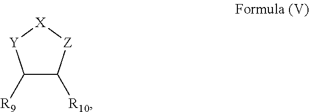
wherein X is selected from any one of 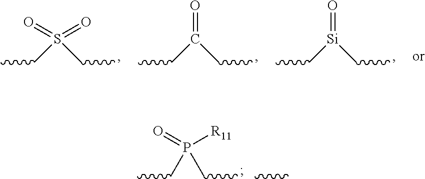
represents a bonding site with an adjacent atom; and Y and Z are each independently selected from any one of C and O; and
R₉, R₁₀, and R₁₁ are each independently selected from H, substituted or unsubstituted C₁ to C₁₀ alkyl, substituted or unsubstituted C₂ to C₁₀ alkenyl, substituted or unsubstituted C₂ to C₁₀ alkynyl, substituted or unsubstituted C₆ to C₁₀ aryl, substituted or unsubstituted C₁ to C₁₀ alkoxy, substituted or unsubstituted C₂ to C₁₀ cycloalkoxy, substituted or unsubstituted C₂ to C₁₀ alkenyloxy, substituted or unsubstituted C₂ to C₁₀ alkynyloxy, substituted or unsubstituted C₆ to C₁₀ aryloxy, substituted or unsubstituted C₁ to C₁₀ carboxyl, substituted or unsubstituted C₁ to C₁₀ carbonyl, substituted or unsubstituted C₁ to C₁₀ cyano, substituted or unsubstituted C₁ to C₁₀ amino, substituted or unsubstituted C₂ to C₁₀ carbonate, substituted or unsubstituted C₁ to C₁₀ sulfate, substituted or unsubstituted C₁ to C₁₀ sulfite, substituted or unsubstituted C₁ to C₁₀ borate, substituted or unsubstituted C₁ to C₁₀ silane, substituted or unsubstituted C₁ to C₁₀ siloxane, and substituted or unsubstituted C₁ to C₁₀ phosphate; wherein when the foregoing groups are substituted, a substituent group of each group is independently selected from at least one of halogen atom or cyano; and
a mass percentage of the compound represented by formula (V) is D % based on the mass of the electrolyte, wherein 0.05≤D≤8.

8. The secondary battery according to claim 7, wherein the compound represented by formula (V) comprises at least one of the following compounds:

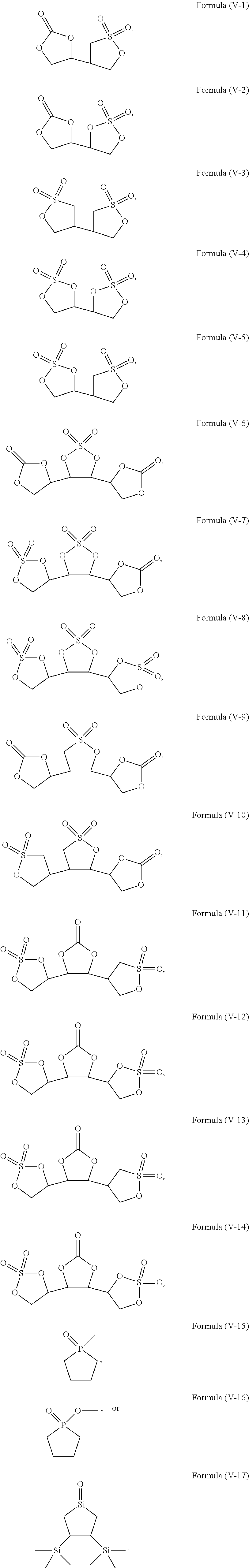

9. The secondary battery according to claim 1, wherein the electrolyte further comprises a nitrile compound, and a percentage of the nitrile compound is E % based on the mass of the electrolyte, wherein 0.1≤E≤8; and
the nitrile compound comprises malononitrile, succinonitrile, glutaronitrile, adiponitrile, suberonitrile, terephthalonitrile, tetradecanedinitrile, azomalononitrile, methyleneglutaronitrile, pentenedinitrile, 1,3,5-benzenetricarbonitrile, 2,4,6-trifluorobenzene-1,3,5-tricarbonitrile, 2-bromobenzene-1,3,5-tricarbonitrile, 1,3,6-hexanetricarbonitrile, 1,2,3-propanetricarbonitrile, 1,3,5-pentanetricarbonitrile, 1,2,6-hexanetricarbonitrile, or at least one of compounds represented by the following formula (VI):

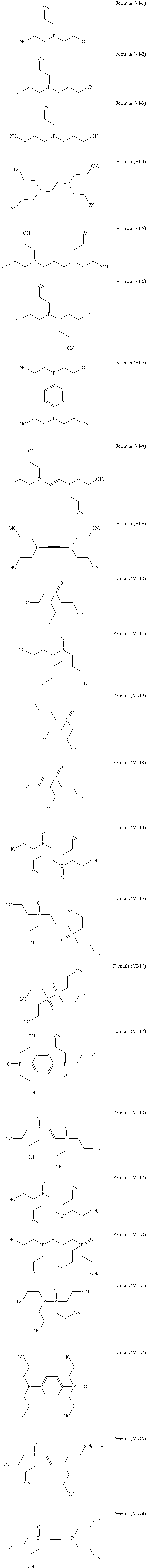

10. The secondary battery according to claim 1, wherein the electrolyte further comprises a carbonate compound and a carboxylate compound, and a mass percentage of the carbonate compound is F % and a mass percentage of the carboxylate compound is G % based on the mass of the electrolyte, wherein 8.3≤F≤33.3, and 8.3≤F+G≤41.6; and
the carbonate compound comprises at least one of ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and the carboxylate compound comprises at least one of methyl acetate, ethyl acetate, propyl acetate, ethyl propionate, propyl propionate, butyl propionate, or amyl propionate.

11. The secondary battery according to claim 10, wherein 0≤G≤21.6.

12. The secondary battery according to claim 1, wherein the electrolyte comprises a lithium salt, and a mass percentage of the lithium salt is H % based on the mass of the electrolyte, wherein 8≤H≤20; and
the lithium salt comprises at least one of lithium hexafluorophosphate, lithium bistrifluoromethanesulfonimide, lithium bis(fluorosulfonyl)imide, lithium tetrafluoroborate, lithium bis(oxalato)borate, lithium difluoro(oxalato)borate, or lithium difluorophosphate.

13. An electronic apparatus, comprising the secondary battery according to claim 1.

14. The electronic apparatus according to claim 13, wherein 0.1≤A≤10, and 45≤B≤75.

15. The electronic apparatus according to claim 13, wherein 0.4≤B/10A≤83.1.

16. The electronic apparatus according to claim 13, wherein a mass percentage of the cobalt is C % based on the mass of the positive electrode material layer, wherein 40≤C≤60.

17. The electronic apparatus according to claim 13, wherein the positive electrode active material comprises Li_{α}Co_{1-x-y}NiₓM_{y}O_{β}, wherein 0.95≤α≤1.4, 0.0005≤x≤0.4, 0≤y≤0.02, 1.9≤β≤2.1, and M comprises at least one of Mn, Al, Mg, Ca, Ti, Zr, V, Cr, Fe, Cu, Zn, Rb, or Sn.

18. The electronic apparatus according to claim 13, wherein the compound represented by formula (I) comprises at least one of the following compounds: 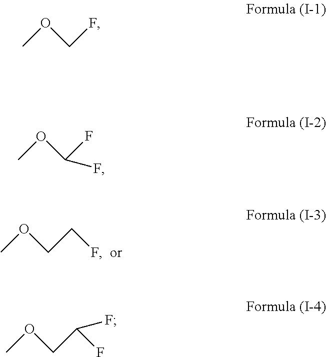
the compound represented by formula (II) comprises at least one of the following compounds: 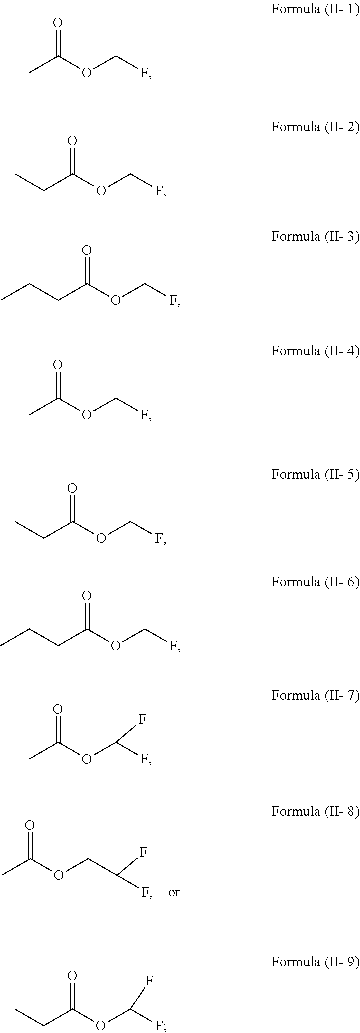
the compound represented by formula (III) comprises at least one of the following compounds: 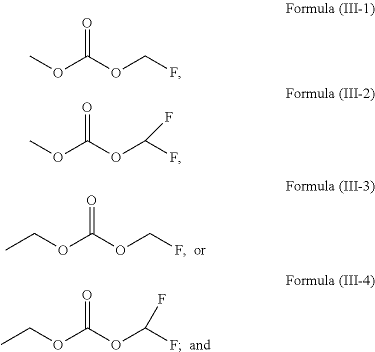
the compound represented by formula (IV) comprises at least one of the following compounds:

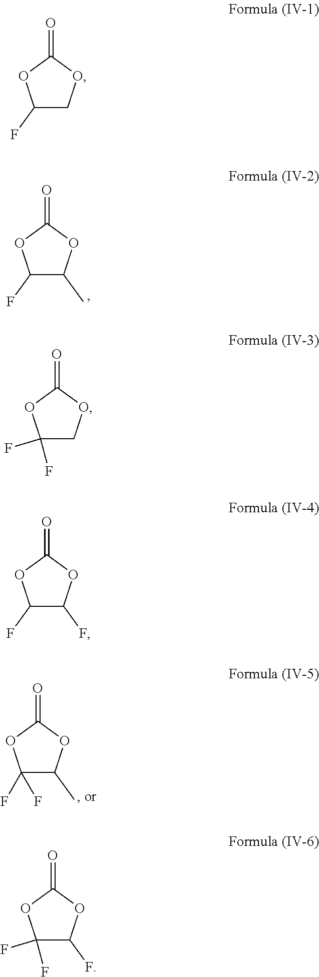

19. The electronic apparatus according to claim 13, wherein the electrolyte further comprises a compound represented by formula (V): 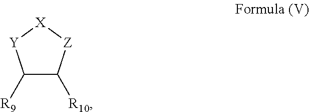
wherein X is selected from any one of 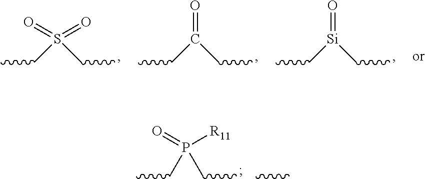
represents a bonding site with an adjacent atom; and Y and Z are each independently selected from any one of C and O; and
R₉, R₁₀, and R₁₁ are each independently selected from H, substituted or unsubstituted C₁ to C₁₀ alkyl, substituted or unsubstituted C₂ to C₁₀ alkenyl, substituted or unsubstituted C₂ to C₁₀ alkynyl, substituted or unsubstituted C₆ to C₁₀ aryl, substituted or unsubstituted C₁ to C₁₀ alkoxy, substituted or unsubstituted C₂ to C₁₀ cycloalkoxy, substituted or unsubstituted C₂ to C₁₀ alkenyloxy, substituted or unsubstituted C₂ to C₁₀ alkynyloxy, substituted or unsubstituted C₆ to C₁₀ aryloxy, substituted or unsubstituted C₁ to C₁₀ carboxyl, substituted or unsubstituted C₁ to C₁₀ carbonyl, substituted or unsubstituted C₁ to C₁₀ cyano, substituted or unsubstituted C₁ to C₁₀ amino, substituted or unsubstituted C₂ to C₁₀ carbonate, substituted or unsubstituted C₁ to C₁₀ sulfate, substituted or unsubstituted C₁ to C₁₀ sulfite, substituted or unsubstituted C₁ to C₁₀ borate, substituted or unsubstituted C₁ to C₁₀ silane, substituted or unsubstituted C₁ to C₁₀ siloxane, and substituted or unsubstituted C₁ to C₁₀ phosphate; wherein when the foregoing groups are substituted, a substituent group of each group is independently selected from at least one of halogen atom or cyano; and
a mass percentage of the compound represented by formula (V) is D % based on the mass of the electrolyte, wherein 0.05≤D≤8.

20. The electronic apparatus according to claim 19, wherein the compound represented by formula (V) comprises at least one of the following compounds: 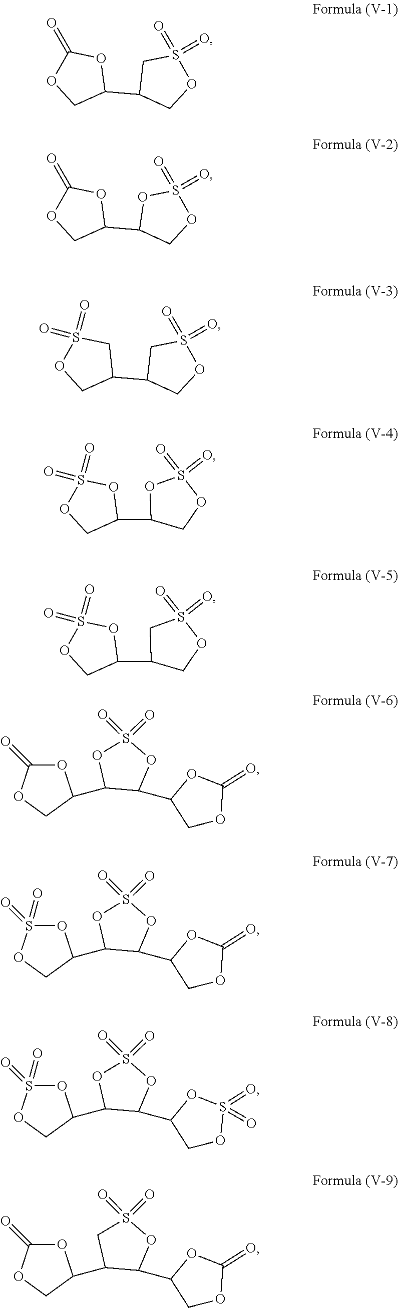 [chemical structure]
